(19) United States
(12) Patent Application Publication
(10) Pub. No.: US 2020/0060293 A1
(43) Pub. Date: Feb. 27, 2020

(54) Microwavable Baking Mixes and Methods of Preparing Baked Goods

(71) Applicant: Baker Mills Inc., Park City, UT (US)

(72) Inventors: Joel Clark, Midway, UT (US); Cameron Smith, Midway, UT (US); Cori Stevens, West Valley City, UT (US)

(21) Appl. No.: 16/673,535

(22) Filed: Nov. 4, 2019

Related U.S. Application Data
(63) Continuation-in-part of application No. 15/384,695, filed on Dec. 20, 2016, now abandoned.
(60) Provisional application No. 62/271,498, filed on Dec. 28, 2015.

(51) Int. Cl. A21D 10/04; A21D 10/00; A21D 2/18; A21D 2/26; A21D 2/34; A21D 2/02

(52) U.S. Cl. CPC A21D 10/045; A21D 10/005; A21D 2/02; A21D 2/266; A21D 2/34; A21D 2/181

(57) ABSTRACT

Baking (e.g., pancake) mixes comprising at least one type of whole grain flour, at least one natural sweetener, at least one solid fat and a leavening system are provided herein. Packaged food products comprising single-serving containers containing said baking (e.g., pancake) mixes, as well as methods of preparing pancakes, are also provided. The baked goods (e.g., pancakes) described herein are preferably 100% whole grain and free from preservatives and/or artificial colorings.

### CROSS REFERENCE TO RELATED APPLICATIONS

This application is a continuation-in-part of U.S. patent application Ser. No. 15/384,695, filed Dec. 20, 2016, which claims priority under 35 U.S.C. § 119(e) to U.S. Provisional Application No. 62/271,498 filed Dec. 28, 2015, the entire contents of each are hereby incorporated herein by reference.

### FIELD OF THE INVENTION

The present invention relates generally to baking (e.g., pancake) mixes which, when combined with water and heated in the microwave, provide baked products (e.g., pancakes). The present invention further extends to packaged food products comprising single-serving containers containing such baking (e.g., pancake) mixes, as well as methods of preparing such baked products (e.g., pancakes).

### BACKGROUND OF THE INVENTION

Pancakes are popular breakfast items. Pancakes are typically made by preparing a dry mix, adding liquid ingredients (e.g., water, milk) to make a batter, and then cooking portions of the batter on the griddle or in a pan. However, in today's busy world, many individuals do not have time to cook breakfast and enjoy the same at the table. Moreover, it is not efficient to prepare an entire batch of pancake mix when only a single pancake is desired.

Pre-made pancakes purchased from the frozen food section of the grocery store can elicit off-tastes and seem dry when re-heated. Moreover, the store-bought frozen pre-made pancakes are often low in nutritional content and contain a variety of artificial ingredients and/or preservatives.

Accordingly, there remains a need for single-serving, nutritional pancake mixes and other baking mixes that can be prepared rapidly and have flavorsome organoleptic qualities.

### SUMMARY OF THE INVENTION

The present invention relates to baking (e.g., pancake) mixes comprising at least one type of whole grain flour, at least one natural sweetener, at least one fat (e.g., a solid fat) and a leavening system. The baking (e.g., pancake) mixes are comprised of 100% whole grain flour and do not contain white flour. In preferred embodiments, the baking (e.g., pancake) mixes are free from preservatives and/or artificial colorings.

The baking (e.g., pancake) mix preferably comprises whole wheat flour and whole grain oat flour. The sweetener is preferably brownulated sugar, optionally in combination with dried honey. The leavening system is preferably baking soda and monocalcium phosphate. The fat is preferably a solid fat, such as a tropical oil or a fraction thereof.

In a particular embodiment, the baking (e.g., pancake mix) comprises a tropical oil selected from the group consisting of coconut oil, palm oil, palm kernel oil or a mixture, fraction or fraction mixture thereof. In one embodiment, the baking mix comprises a fat selected from the group consisting of palm oil flakes, coconut oil flakes, palm kernel flakes or mixtures thereof.

The baking (e.g., pancake) mixes may further comprise additional ingredients, e.g. milk products, protein sources, flavorings, fruit, and spices.

The present invention also relates to packaged food products comprising a single-serving container containing a baking (e.g., pancake) mix. In one embodiment, the single-serving container is selected from a cup, pouch, box or bag. The single-serving containers are made from microwavable materials and have a lid sealing the pancake mix in the single-serving container.

In a particular embodiment, the single-serving container is a cup. In a more particular embodiment, the single-serving container is a cup comprising a plastic lid sealing the pancake mix in the single-serving container.

The present invention also relates to methods of preparing baked goods (e.g., pancakes). In one embodiment, a method of preparing a baked good (e.g., pancake) comprises (i) providing a baking (e.g., pancake) mix of the present invention, (ii) providing water, (iii) adding the water to the baking mix to provide a batter, (iv) optionally, stirring the batter and (v) microwaving the batter for a sufficient time to provide a baked good (e.g., a pancake). In some embodiments, the batter in (iv) is stirred.

In another embodiment, a method of preparing a baked good (e.g., pancake) comprises (i) providing a packaged food product comprising a single-serving container containing a baking (e.g., pancake mix) as disclosed herein, wherein the single serving contain has a lid sealing said baking (e.g., pancake) mix within said single-serving container, wherein the baking (e.g., pancake) mix is present in an amount of about 60 g to about 65 g, (ii) providing water in an amount of about ¼ cup, (iii) removing the lid sealing said baking (e.g., pancake) mix within the single-serving container, (iv) adding the water to the baking mix to provide a batter, (v) optionally, stirring the batter and (vi) microwaving the batter in the single-serving container for between about 45 seconds and about 2 minutes to provide a baked good (e.g., pancake) in the single-serving container. In some embodiments, the batter in (v) is stirred.

In another embodiment, a method of preparing a baked good (e.g., a pancake) comprises (i) providing a packaged food product comprising a single-serving cup containing a baking (e.g., pancake mix), wherein the single-serving cup has a plastic lid sealing said baking (e.g., pancake) mix within said single-serving cup, wherein the baking (e.g., pancake) mix is present in an amount of about 60 g to about 65 g, (ii) providing water in an amount of about ¼ cup, (iii) removing the lid sealing said baking (e.g, pancake) mix within the single-serving cup, (iv) adding the water to the baking mix to provide a batter, (v) optionally, stirring the batter and (vi) microwaving the batter in the single-serving cup for between about 45 seconds and about 2 minutes to provide a baked good (e.g., pancake) in the single-serving cup. In some embodiments, the batter in (v) is stirred.

The present invention also relates to baked good (e.g., pancakes) prepared by the methods provided herein. In certain embodiments, the baked goods (e.g., pancakes) have organoleptic properties similar to baked goods (e.g., pancakes) prepared in a conventional oven or on a hot surface (e.g., a griddle). In a particular embodiment, the baked goods (e.g., pancakes) have a similar texture and/or mouthfeel) to baked goods (e.g., pancakes) prepared in a conventional oven or on a hot surface (e.g., a griddle).

### DETAILED DESCRIPTION OF THE INVENTION

### I. Definitions

The term “baked product”, as used herein, refers to a food obtained by cooking and possible leavening of doughs wherein the main ingredients are flour and water.

The term “baking mix” or “prepared baking mix”, as used herein, refers to a mix of dry ingredients to which liquid can be added to produce a batter which is then cooked to produce a baked product.

The term “batter”, as used herein, refers to a semi-liquid to liquid mixture of flour, water, and other ingredients that can generally be poured at room temperature. A batter generally has a thinner consistency than dough. In embodiments described herein, the batter is an intermediate food product made by adding a liquid to a baking mix, which generally cooks into a soft, moist baked product (e.g., pancake).

The term “container” and “packaged”, as used herein, are used inter-changeably to indicate an article that is shaped to hold food products.

The term “cut in”, as used herein, refers to a method of incorporating a solid fat into dry ingredients just until the fat is in small, granular pieces.

The term “leavening”, as used herein, refers to the production of a gas in a batter using an agent like baking powder, yeast, baking soda, or even eggs.

The term “mouthfeel”, as used herein, refers to the tactile sensations perceived by the lining of the mouth, including the tongue, gums and teeth. Associated terms include, for example, cohesiveness, density, astringency, dryness, fracturability, graininess, gumminess, hardness, heaviness, moisture absorption, moisture release, mouthcoating, roughness, slipperiness, smoothness, toughness, uniformity, uniformity of bite, uniformity of chew, viscosity and wetness of the food composition when placed in the mouth.

The term “organoleptic properties” or “sensory properties”, as used herein, refers to those are the aspects of a food product (e.g., a baked product) that create an individual experience via the senses—including taste, sight, smell, and touch. In certain embodiments, the baked goods disclosed herein have improved organoleptic properties compared to conventional baked goods prepared in the microwave, such as improved texture, improved appearance, etc. These properties may be measured by human subjects, for example in a sensory panel (e.g., a textural sensory panel), or by appropriate analysis techniques.

The term “pancake mix”, as used herein, refers to the dry mix of ingredients that, when combined with water and heated, results in a pancake.

The term “pancake”, as used herein, refers to a thin, flat cake of batter. Pancake batter typically contains whole grain flour, water, sugar, fat and a leavening system. The term pancake is used synonymously with flapjack, hotcake and griddlecake, among others. The specific name varies depending on geography. In certain embodiments, pancakes make contain one or more inclusions, e.g., fruit, nuts, candies, chocolate or similar.

The term “texture”, as used herein, refers to all the mechanical, geometrical and surface attributes of a product perceptible by means of mechanical, tactile, and, where appropriate, visual and auditory receptors. Texture can be measured, for example, by a texture sensory panel or by appropriate analysis. Different methods for testing the texture of bakery products are known in the art (e.g., compression, penetrance, shear, tension and puncture methods). In certain embodiments, pancake texture is tested on a Steven's QTS Texture Analyzer (Michael G. Brown & Assoc., Inc., Newtown, Pa.) using texture profile analysis (TPA).

### II. Baking Mixes

Disclosed herein are baking mixes and in particular, a microwaveable baking mix and even more particularly, a packaged (e.g., single-serving) microwaveable baking mix. In certain embodiments, the packaged food product is not intended for preparation (heating) in a conventional oven or on a hot surface (e.g., a griddle).

The baking mixes disclosed herein can be used to produce baked goods including, but not limited to, pancakes, muffins, cakes, brownies, and the like.

In a particular embodiment, the baking mix is not a muffin mix.

The baking mix (e.g., pancake mix) of the present invention comprises at least one type of whole grain flour, at least one natural sweetener, at least one fat and a leavening system. The baking (e.g., pancake) mix can further comprise additional components, described herein below.

The baking (e.g., pancake) e mix of the present invention comprises at least one type of whole grain flour. In a particular embodiment, the baking (e.g., pancake) mix comprises two types of whole grain flour. In particularly desirable embodiments, the only flour(s) present in the pancake mix is whole grain flour(s), i.e. the pancake mix does not contain white flour.

“Whole grain flour,” as used herein, refers to flour that is formed by grinding entire kernels of a whole grain into flour. A whole grain flour may also include a composition in which the bran, endosperm and germ were separately processed or ground and the processed portions were recombined.

Suitable whole grain flours include, but are not limited to, flours from amaranth, barley, buckwheat, bulgur, corn, einkorn, faro, fonio, freekeh, kamut, kaniwa, millet (pearl millet (Pennisetum glaucum), foxtail millet (Setaria italica), proso millet (Panicum miliaceum), finger millet/ragi (Eleucine coracana), and fonio (Digitaria exilis)), oat, quinoa, rice, rye, sorghum, spelt, teff, triticale, wheat, wild rice and combinations thereof.

The amount of whole grain flour in the baking (e.g., pancake) mix is typically from about 40% to about 60% by weight on a dry basis, such as, for example, from about 40% to about 55%, from about 40% to about 50%, from about 40% to about 45%, from about 45% to about 60%, from about 45% to about 55%, from about 45% to about 50%, from about 50% to about 60% and from about 55% to about 60%.

In one embodiment, the baking (e.g., pancake) mix comprises whole wheat flour and whole grain oat flour.

The amount of whole wheat flour in the baking (e.g., pancake) mix is typically from about 30% to about 40% by weight on a dry basis, such as, for example, from about 30% to about 35% and from about 35% to about 40%.

The amount of whole grain oat flour in the baking (e.g., pancake) mix is typically from about 10% to about 20%, such as, for example, about 10% to about 15% and about 15% to about 20%. In another embodiment, the baking (e.g., pancake) mix comprises whole grain oat flour in an amount of about 10%, about 11%, about 12%, about 13%, about 14%, about 15%, about 16%, about 17%, about 18% or about 19%.

In one embodiment, the baking (e.g., pancake) mix comprises whole wheat flour and whole grain oat flour in a combined amount of about 40% to about 60% by weight on a dry basis. In a more particular embodiment, the baking (e.g., pancake) mix comprises whole wheat flour and whole grain oat flour in a combined amount of about 40% to about 60% by weight on a dry basis, wherein whole wheat flour is present in an amount from about 30% to about 40% by weight on a dry basis and whole grain oat flour is present in an amount from about 10% to about 20% by weight on a dry basis.

The baking (e.g., pancake) mix of the present invention also comprises a natural sweetener. Suitable sweeteners include, but are not limited to, agave, barley malt syrup, brown rice syrup, cane sugar, muscovado sugar, turbinado sugar, demerara sugar, coconut sugar, date sugar, honey, molasses, sugar alcohols (e.g. erythritol, maltitol, mannitol, sorbitol, and xylitol). In other embodiments, the natural sweetener is a sugar. Suitable sugars include, but are not limited to, pentoses such as fructose, xylose, arabinose, glucose, galactose, amylose, fructose, sorbose, lactose, maltose, dextrose, sucrose, maltodextrins, molasses, brown sugar, brownulated sugar and combinations thereof.

The amount of natural sweetener in the baking (e.g., pancake) mix will depend on the identity of the natural sweetener. Typically, the pancake mix comprises a natural sweetener in an amount from about 5% to about 10% by weight on a dry basis, such as, for example, about 5%, about 6%, about 7%, about 8%, about 9% or about 10%.

In one embodiment, the natural sweetener comprises brownulated sugar. In another embodiment, the natural sweetener comprises a combination of brownulated sugar and brown sugar. In still another embodiment, the natural sweetener comprises a combination of brownulated sugar and dried honey.

The brownulated sugar is typically present in the pancake mix in an amount from about 5% to about 10%, such as, for example, about 5%, about 6%, about 7%, about 8%, about 9% or about 10%.

The baking (e.g., pancake) mix of the present invention also comprises a leavening system. “Leavening system”, as used herein, refers to a mixture, usually at least one acid and one base, that react to form carbon dioxide, thereby causing the baked product (e.g., pancake) to rise. Compounds that promote leavening are well known in the art and include, but are not limited to, baking soda (sodium bicarbonate or potassium bicarbonate), monocalcium phosphate monohydrate (MCP), (MCP), sodium acid pyrophosphate (SAPP), sodium aluminum phosphate (SALP), dicalcium phosphate dihydrate (DPD), dicalcium phosphate (DCP), sodium aluminum sulfate (SAS), glucono-deltalactone (GDL), potassium hydrogen tartrate (cream of tartar) and combinations thereof.

In one embodiment, the leavening system comprises baking soda. In a more particular embodiment, the leavening system comprises baking soda and monocalcium phosphate. In a still more particular embodiment, the leavening system consists of baking soda and monocalcium phosphate.

Typically, the baking (e.g., pancake) mix comprises the leavening system in an amount from about 0.5% to about 3.5% by weight on a dry basis, such as, for example, from about 0.5% to about 3%, from about 0.5% to about 2.5%, from about 0.5% to about 2%, from about 0.5% to about 1.5%, from about 1.5% to about 1%, from about 1% to about 3.5%, from about 1% to about 3%, from about 1% to about 2.5%, from about 1% to about 2%, from about 1.5% to about 3.5%, from about 1.5% to about 3%, from about 1.5% to about 2.5%, from about 1.5% to about 2%, from about 2% to about 3.5%, from about 2% to about 3%, from about 2% to about 2.5%, from about 2.5% to about 3% and from about 3% to about 3.5%.

In a particular embodiment, the baking (e.g., pancake) mix comprises the leavening system in an amount from about 1.5% to about 2.5% by weight on a dry basis, such as, for example, about 1.5%, about 1.7%, about 1.9% and about 2.1%.

The baking (e.g., pancake) mix of the present invention also comprises a fat. The fat may be, for example, a fat that is liquid, semi-solid or solid at room temperature. Solid fat index (SFI) provides a measure of the amount of solid fat present in a sample. In a particular embodiment, the fat source used to prepare the baking mix of the present invention has a SFI of at least about 20, at least about 30, at least about 40, at least about 50, at least about 60 or at least about 70% or more.

Fats that are solid at room temperature may come from plants or animals. In a particular embodiment, the solid fat is a solid fat derived from plants such as tropical oils (TO), e.g., coconut, palm, palm kernel, sal, kokum, mango kernel oil or fractions, mixtures or fragment mixtures thereof. In certain embodiments, the tropical oil is sustainably harvested.

In a particular embodiment, the fat source in the baking mix (e.g., pancake mix) disclosed herein is a tropical oil flake (having a relatively small thickness compared to its length or breadth) or chunk (having a relatively large thickness compared to its length and breadth). In one embodiment, the fat source is selected from a coconut oil flake or chunk, palm oil flake or chunk, palm kernel oil flakes or chunks or mixtures thereof.

In embodiment, the fat source is a fractionated palm oil or fractionated palm kernel oil. Palm oil is pressed from the flesh of the fruit, and palm kernel oil from the seed or kernel. The palm oil and palm kernel oil can be fractionated using crystallization and separation processes to obtain more solid (stearin) fractions and more liquid (olein) fractions. In certain embodiments, the oils also can be hydrogenated and/or interesterified, while in alternative embodiments, the oils are not hydrogenated and/or interesterified.

Solid fat sources (e.g., palm oil flakes) have been found to affect both the taste and rising characteristics of the baking (e.g., pancake) mix. Use of palm oil results in a pancake that does not rise consistently and causes the pancake to “fall”. The pancake falls regularly when water is added to the pancake mix in amounts larger than the advised amount. Use of a solid fat such as palm oil flakes, in contrast, results in a pancake that rises consistently—even when larger water amounts are added to the pancake mix. Not wishing to be bound by theory, solid fats such as palm oil flakes also provide richness to the pancake, and allow for reduced pancake sugar content.

In a particular embodiment, the baking mix is prepared without the addition of a liquid fat or oil.

The baked product produced from the baking mix disclosed herein may have one or more improved properties, e.g., organoleptic or nutritional properties, compared to conventionally microwaved baked products. The improvement can be measured, for example, by sensory evaluation, instrumental evaluation or a combination thereof. For a review of sensory evaluation, see Stone H., and Sidel J. L., (1993), Sensory evaluations practices, California: Academic Press. When a sensory panel is utilized, the panelists may be objective panelists (i.e., trained sensory panelists) or subject panelists (e.g., consumers). The method of sensory analysis may vary and include, for example, a paired preference test, a preference ranking test, or a hedonic test method (ASTM, 1968; Meilgaard et al., 1991; Stone and Sidel, 1985).

In a particular embodiment, the baked good may have one or more improved organoleptic properties selected from flavor, aroma, texture, visual appearance (e.g., color, size) or the like.

Flavor is sensory phenomenon which is used to denote the sensations of odor, taste and mouthfeel of a substance. Taste helps in identification, acceptance and appreciation of food. It is perceived by the taste buds on the tongue. There are four types of taste perception: sweet, salty, sour and bitter.

Texture refers to the sensory manifestation of the structure or inner make up of foods. The following textural terms are generally pertinent to baked goods: firmness, springiness, adhesiveness (to lip, palate, teeth), crumbliness/self-adhesiveness, moistness, cohesiveness/deformation, moisture sorption and cohesiveness of mass. In certain embodiments, the baked mix disclosed herein produces a baked good having improved textural characteristics with respect to one or more of these textural properties.

In one embodiment, the baked good produced from the baking mix disclosed herein may have improved characteristics selected from the group consisting of volume, moisture, oven spring, weight, density, color and shelf life.

The volume of a baked good can be determined, e.g., using Method 10-91.01 (AACC International 2010). The moisture content of a baked good can be determined, e.g., using Method 44-40.01 (AACC International 2010). Firmness and springiness can be measured, e.g., Firmness and springiness were measured using Method CAK1/P36R (Stable Microsystems 2011). In terms of color, the lightness, chroma and hue values of a baked good can be determined using a colorimeter (Minolta Chroma Meter CR-410, Konica Minolta Holdings, Tokyo, Japan)

In one embodiment, the baked product produced from the baking mix disclosed herein may have one or more organoleptic or nutritional properties similar to a baked good (e.g., a pancake) produced by conventional heating, e.g., in an oven or on a hot surface such as a griddle.

In a particular embodiment, the baked good produced from the baking mix disclosed herein has acceptable rising and flow properties during the baking process to ensure the production of a baked product of the desired size and shape. In general, during microwave baking, the batter does not collapse.

In a particular embodiment, the baked good produced from the baking mix disclosed herein is evenly cooked.

In a particular embodiment, the baked product produced by microwaving the baking mix disclosed herein has improved textural characteristics compared to a conventional microwaveable baking mix or similar textural characteristics to an oven-baked product. In one embodiment, the texture parameter is selected from firmness, gumminess, chewiness, cohesiveness and/or springiness) In one embodiment, the baked product maintains desirable textural characteristics upon reheating.

In another particular embodiment, the baked product produced by microwaving the baking mix disclosed herein has reduced microwave-induced toughness compared to a conventional microwaveable baking mix or similar toughness compared to an oven-baked product

In a particular embodiment, the baked product produced by microwaving the baking mix disclosed herein has reduced moisture loss compared to a conventional microwaveable baking mixes. In one embodiment, the baked product maintains desirable moisture characteristics upon reheating.

In another particular embodiment, the baked product produced by microwaving the baking mix disclosed herein has reduced shrinkage compared to a conventional microwaveable baking mixes. In one embodiment, the baked product maintains desirable product volume characteristics upon reheating.

Other suitable fats include, but are not limited to, oils such as cottonseed oil, nut oil, soybean oil, sunflower oil, rapeseed oil, sesame oil, olive oil, corn oil, safflower oil, palm oil, palm kernel oil, coconut oil, and combinations thereof.

Typically, the baking (e.g., pancake) mix comprises fat in an amount from about 5% to about 13%, such as, for example, from about 5% to about 10%, about 7% to about 12% or about 10% to about 15%.

In a particular embodiment, the fat comprises palm oil. In a more particular embodiment, the fat comprises palm oil flakes. In an even more particular embodiment, the fat consists of palm oil flakes.

The baking (e.g., pancake) mix of the present invention may further comprise maple syrup flakes. Use of maple syrup flakes is preferable to maple syrup flavoring and/or maple syrup pellets (the latter comprising palm oil, sugar and maple flavoring). Maple syrup flakes provide discrete pockets of maple flavor—as in traditional pancake preparation, whereas maple flavoring and maple syrup pellets provides a more homogenous dispersal of maple flavor throughout the pancake.

Typically, the baking (e.g., pancake) mix comprises maple syrup flakes in an amount from about 10% to about 15% by weight on a dry basis, such as, for example, about 10%, about 11%, about 12%, about 13%, about 14% or about 15%.

The baking (e.g., pancake) mix of the present invention may further comprise milk solids. “Milk solids”, as used herein, refers to dried milk following evaporation of water. In some cases, additional substances are also removed, e.g. non-protein constituents. Suitable milk solids include, but are not limited to, dried milk including non-fat dried milk, milk protein isolates and combinations thereof.

Typically, the baking (e.g., pancake) mix comprises milk solids in an amount from about 1% to about 8% by weight on a dry basis, such as, for example, from about 2% to about 6% or about 3% to about 5%.

The baking (e.g., pancake) mixes of the present invention may further comprise whey protein concentrate. Typically, the baking (e.g., pancake) mix comprises whey protein concentrate in an amount from about 0.5% to about 5% by weight on a dry basis, depending on the desired protein content. In protein-enriched baking (e.g., pancake) mixes, the whey protein concentrate can be present in an amount of at least 3% by weight on a dry basis. In more typical baking (e.g., pancake) mixes, the wheat protein isolate can be present in an amount from about 0.5% to about 1% by weight on a dry basis.

The baking (e.g., pancake) mixes of the present invention may also further comprise wheat protein isolate. Typically, the baking (e.g., pancake) mix comprises wheat protein isolate in an amount from about 0.5 to about 10% by weight, depending on the desired protein content. In protein-enriched baking (e.g., pancake) mixes, the wheat protein isolate can be present in an amount of at least 5% by weight on a dry basis. In more typical baking (e.g., pancake) mixes, the wheat protein isolate can be present in an amount from about 0.5% to about 3% by weight on a dry basis.

In certain embodiments, the baking (e.g., pancake) mixes of the present invention may also further comprise fruit, typically dried fruit. Suitable fruit includes, but is not limited to, acai, apples, apricots, bananas, bilberries, blackberries, blueberries, boysenberries, camu camu, cantaloupes, cherries, chokeberries, coconuts, cranberries, dates, elderberries, figs, goji berries, gooseberries, guava, jackfruit, kiwis, lemons, lucuma, mangos, mangosteens, maquis, mulberries, nectarines, noni, oranges, dragon fruits, papayas, peaches, pears, persimmons, pineapples, plums, pluots, pomegranates, raisins, raspberries, star fruits, strawberries and combinations thereof.

The amount of fruit in the baking (e.g., pancake) mix can vary depending on the fruit and the desired taste. Typically, the baking (e.g., pancake) mix comprises fruit in an amount from about 0.5% to about 5% by weight on a dry basis, such as, for example, about 1%, about 2%, about 3%, about 4% and about 5%.

In addition to the foregoing, other ingredients known to those of skill in the art can be included in the baking (e.g., pancake) mixes to give a variety of desired properties, flavors and/or textures. Examples of these ingredients include flavoring and coloring agents, flavors, such as vanilla flavor, butter flavor, buttermilk powder, and spices, such as salt and cinnamon. Suitable amounts of flavoring and coloring agents, flavors and spices include 0.1-3% by weight of the pancake mix on a dry basis.

In one embodiment, a baking (e.g., pancake) mix comprises at least one type of whole grain flour, at least one natural sweetener, at least one fat and a leavening system.

In a more particular embodiment, a protein-enriched (e.g., pancake) mix comprises at least one type of whole grain flour, at least one natural sweetener, at least one fat and a leavening system, wherein the protein content of the baking (e.g., pancake mix) is at least 9% by weight on a dry basis. The protein content can comprise milk solids, whey protein concentrates and wheat protein isolate.

In a particular embodiment, the at least one type of whole grain flour comprises a combination of whole wheat flour and whole grain oat flour; the at least one natural sweetener comprises brownulated sugar and dry honey, the at least one fat comprises palm oil flakes and the leavening system comprises baking soda and monocalcium phosphate. In some embodiment, the pancake mix further comprises flavors and spices, such as, for example, butter flavor, maple flakes and salt.

In another embodiment, a maple-flavored baking (e.g., pancake) mix comprises at least one type of whole grain flour, at least one natural sweetener, at least one fat, maple syrup flakes and a leavening system.

In a particular embodiment, the at least one type of whole grain flour comprises a combination of whole wheat flour and whole grain oat flour, the at least one natural sweetener comprises brownulated sugar and dry honey, the at least one fat comprises palm oil flakes and the leavening system comprises baking soda and monocalcium phosphate. In some embodiment, the baking (e.g., pancake) mix further comprises cinnamon flakes and/or dried blueberries.

### III. Containers

The present invention also provides a packaged food product. The package may contain a quantity of the food product suitable for use by one or more individuals. In certain embodiments, the package or container permits the food product to be consumed directly therefrom, i.e., without the need for a separate dish or the like.

In a particular embodiment, a single-serving container (package) is disclosed containing a baking (e.g., pancake) mix of the present invention. The container is suitable for storing and/or preparing (cooking) the baking mix to provide a baked good. Any of the baking (e.g., pancake) mixes described herein above can be used. The single-serving containers typically comprise between about 60 and about 65 g of the pancake mix. A suitable single-serving container includes, but is not limited to, a cup, pouch, box or bag. In certain embodiments, a lid seals the baking (e.g., pancake) mix within the single-serving container. The single-serving container can be made from any microwavable material. In a particular embodiment, the single-serving container is not intended for use in a conventional oven.

In one embodiment, the single-serving container is a single-serving cup. The top and bottom of the single-serving cup are typically flat, and the side of the container is rounded. In some embodiments, a plastic lid seals the pancake mix within the single-serving cup. The single-serving cup can be made from any microwavable material, such as, for example, paper or paper board. The single-serving cup is optionally lined with polypropylene, polyethylene or a combination thereof.

In certain embodiments, the microwaveable material is selected from the group consisting of glass, and many types of plastic, including crystallized polyethylene terephthalate (CPET), aliphatic crystalline grades of nylon, thermosetting polyester, polypropylene, poly carbanate, polyetherimide, and high impact polystyrene.

In certain embodiments, the microwaveable material is a sustainable material. In one embodiment, the microwaveable material is a bio-based or biodegradable materials, i.e., a bio-based plastic. In another embodiment, the microwaveable material is a paper composite.

Typically, the single-serving cup is between about 3 and about 4 inches high, such as, for example, about 3.25 inches, about 3.50 inches or about 3.75 inches. In a preferred embodiment the single-serving cup is about 3.25 inches high.

The outer diameter of the top of the single-serving cup is typically from about 3 to about 4.0 inches wide, such as, for example, from about 3.0 to about 3.75 inches, from about 3.0 to about 3.5 inches, from about 3.0 to about 3.25, from about 3.25 to about 4.0 inches, from about 3.25 to about 3.75 inches, from about 3.25 to about 3.5 inches, from about 3.5 to about 4.0 inches, from about 3.5 to about 3.75 inches and from about 3.75 to about 4.0 inches. In a preferred embodiment, the outer diameter is from about 3.5 to about 3.75 inches.

The outer diameter of the bottom of the single-serving cup is typically from about 2.0 to about 3.0 inches, such as, for example, from about 2.0 to about 2.75 inches, from about 2.0 to about 2.5 inches, from about 2.0 to about 2.25 inches, from about 2.25 to about 3 inches, from about 2.25 to about 2.75 inches, from about 2.25 to about 2.5 inches, from about 2.5 to about 3.0 inches, from about 2.5 to about 2.75 inches and from about 2.75 inches to about 3 inches. In a preferred embodiment, the outer diameter is from about 2.75 to about 3 inches.

### IV. Pancakes and Methods of Preparing Baked Products

The present invention also provides a method of preparing a baked product such as a pancake. In one embodiment, a method of preparing a pancake comprises (i) providing a baking (e.g., pancake) mix of the present invention, (ii) providing water, (iii) adding the water to the pancake mix to provide a batter, (iv) optionally, stirring the batter and (v) microwaving the batter for a sufficient time to provide a baked good (e.g., pancake). In particular embodiments, the batter in (iv) is stirred.

“Pancake batter”, as used herein, refers to wetted pancake mix, i.e. pancake mix and water.

Any pancake mix disclosed herein above can be used in the method.

The amount of water added is usually between ⅕ and ⅓ of a cup, typically around 1/4 of a cup, per 60-65 g of pancake mix. This same ratio of water to baking (e.g., pancake) mix can be used depending on the amount of baking (e.g., pancake) mix.

The amount of time required to heat the batter in the microwave varies depending on microwave power. Typically, the batter is headed in the microwave on normal power for from about 45 seconds to about 2 minutes, such as, for example, about 1 minute or about 1.5 minutes.

In a particular embodiment, a method of preparing a baked good (e.g., a pancake) is disclosed, comprising (i) providing a baking (e.g., pancake) mix of the present invention in an amount of about 60 to about 65 g, (ii) providing water in an amount of about ¼ cup, (iii) adding the water to the baking mix to provide a batter, (iv) optionally, stirring the batter and (v) microwaving the batter for between about 45 seconds and about 2 minutes to provide the baked good (e.g., pancake_.

In another embodiment, a method of preparing a baked good (e.g., pancake) comprises (i) providing a packaged food product comprising a single-serving container containing a baking (e.g., pancake) mix having a lid sealing said pancake mix within said single-serving container, wherein the baking (e.g., pancake) mix is present in an amount of about 60 g to about 65 g, (ii) providing water in an amount of about ¼ cup, (iii) removing the lid sealing said baking (e.g., pancake) mix within the single-serving container, (iv) adding the water to the baking (e.g., pancake) mix to provide a batter, (v) optionally, stirring the batter and (vi) microwaving the batter in the single-serving container for between about 45 seconds and about 2 minutes to provide a baked good (e.g., pancake) in the single-serving container.

In a more particular embodiment, a method of preparing a baked good (e.g., pancake) comprises (i) providing a packaged food product comprising a single-serving cup containing a pancake mix having a plastic lid sealing said baking (e.g., pancake) mix within said single-serving cup, wherein the baking (e.g., pancake) mix is present in an amount of about 60 g to about 65g, (ii) providing water in an amount of about ¼ cup, (iii) removing the lid sealing said baking (e.g., pancake) mix within the single-serving cup, (iv) adding the water to the baking (e.g., pancake) mix to provide a batter, (v) optionally, stirring the batter and (vi) microwaving the batter in the single-serving cup for between about 45 seconds and about 2 minutes to provide a baked good (e.g., pancake) in the single-serving cup. In a particular embodiment, the batter in (v) is stirred.

The baked good (e.g., pancakes) of the present invention, prepared by the methods above, are superior to store-bought frozen baked good (e.g., pancakes) as found in the grocery store. The baked goods (e.g., pancakes) of the present invention are moist. The baked goods (e.g., pancakes) of the present invention made from 100% whole-grain flour. In some embodiments, the baked goods (e.g., pancakes) of the present invention do not contain preservatives and/or artificial colorings.

Pancakes prepared by the methods herein above are typically about 2 to about 3 inches high, such as, for example, from about 2.0 to about 2.75 inches, from about 2.0 to about 2.5 inches, from about 2.0 to about 2.25 inches, from about 2.25 to about 3.0 inches, from about 2.25 to about 2.75 inches, from about 2.25 to about 3.0 inches, from about 2.5 to about 3.0 inches, from about 2.5 to about 2.75 inches and from about 2.75 to about 3.0 inches. In a preferred embodiment, the pancake is typically about 2.5 inches high.

In one embodiment, the present invention is a baked good (e.g., pancake) comprising at least one type of whole grain flour, at least one natural sweetener, at least one fat, a leavening system and water. The baked good (e.g., pancake) can be fruit-flavored and/or maple syrup-flavored. In one embodiment, the baked good (e.g., pancake) is blueberry and maple-flavored. In another embodiment, the baked good (e.g., pancake) is cinnamon and maple-flavored.

In a more particular embodiment, a protein-enriched pancake comprises at least one type of whole grain flour, at least one natural sweetener, at least one fat, a leavening system, and water. The protein content can comprise milk solids, whey protein concentrate and wheat protein isolate.

In a particular embodiment, the at least one type of whole grain flour comprises a combination of whole wheat flour and whole grain oat flour; the at least one natural sweetener comprises brownulated sugar and dry honey, the at least one fat comprises a fat (e.g., a solid fat such as a tropical oil fat and in particular, palm oil flakes and the leavening system comprises baking soda and monocalcium phosphate. In some embodiment), the baked good (e.g., pancake) further comprises flavors and spices, such as, for example, butter flavor, maple flakes and salt.

In another embodiment, a maple-flavored baked good (e.g., pancake) comprises at least one type of whole grain flour, at least one natural sweetener, at least one fat (e.g., a solid fat such as a tropical oil fat, for example, palm oil flakes), maple syrup flakes, a leavening system and water.

In a particular embodiment, the at least one type of whole grain flour comprises a combination of whole wheat flour and whole grain oat flour; the at least one natural sweetener comprises brownulated sugar and dry honey, the at least one fat comprises a solid fat (e.g., a tropical oil fat, such as palm oil flakes) and the leavening system comprises baking soda and monocalcium phosphate. In some embodiments, the pancake further comprises cinnamon and/or dried blueberries.

1. A packaged food product comprising a single-serving container and a baking mix comprising at least one type of whole grain flour, at least one natural sweetener, at least one fat and a leavening system, wherein the baking mix is free from white flour and the at least one fat is a solid fat.

2. The packaged food product of claim 1, wherein the baking mix is pancake mix.

3. The packaged food product of claim 1, wherein the at least one type of whole grain flour is selected from the group consisting of flours from amaranth, barley, buckwheat, bulgur, corn, einkorn, faro, fonio, freekeh, kamut, kaniwa, millet (pearl millet (Pennisetum glaucum), foxtail millet (Setaria italica), proso millet (Panicum miliaceum), finger millet/ragi (Eleucine coracana), and fonio (Digitaria exilis)), oat, quinoa, rice, rye, sorghum, spelt, teff, triticale, wheat, wild rice and combinations thereof.

4. The packaged food product of claim 3, wherein the at least one type of whole grain flour comprises whole wheat flour and whole grain oat flour.

5. The packaged food product of claim 1, wherein the baking mix is free from preservatives and/or artificial colorings.

6. The packaged food product of claim 1, wherein the at least one natural sweetener is selected from the group consisting of agave, barley malt syrup, brown rice syrup, cane sugar, muscovado sugar, turbinado sugar, demerara sugar, coconut sugar, date sugar, honey, molasses, sugar alcohols (e.g. erythritol, maltitol, mannitol, sorbitol, and xylitol), pentoses such as fructose, xylose, arabinose, glucose, galactose, amylose, fructose, sorbose, lactose, maltose, dextrose, sucrose, maltodextrins, molasses, brown sugar, brownulated sugar and combinations thereof.

7. The packaged food product of claim 5, wherein the at least one natural sweetener comprises brownulated sugar and, optionally, brown sugar and/or dried honey.

8. The packaged food product of claim 5, wherein the at least one natural sweetener is present in an amount from about 5% to about 10% by weight on a dry basis.

9. The packaged food product of claim 1, wherein the at least one solid fat is a tropical oil.

10. The packaged food product of claim 1, wherein the at least on solid fat is selected from the group consisting of coconut oil, palm oil, palm kernel oil or mixtures, fragments or fragment mixtures thereof.

11. The packaged food product of claim 10, wherein the at least one solid fat is palm oil in the form of palm oil flakes.

12. The packaged food product claim 9, wherein the at least one solid fat is present in an amount from about 5% to about 13% by weight on a dry basis.

13. The packaged food product of claim 1, wherein the leavening system comprises baking soda and monocalcium phosphate.

14. The packaged food product of claim 1, wherein the baking mix further comprises maple syrup flakes.

15. The packaged food product of claim 14, wherein the maple syrup flakes are present in an amount from about 10% to about 15% by weight on a dry basis.

16. The packaged food product of claim 1, wherein the baking mix further comprises whey protein concentrate and/or wheat protein isolate.

17. The packaged food product of claim 1, wherein the single-serving container contains from about 60 g to about 65 g of the baking mix.

18. The packaged food product of claim 1, wherein the single-serving container is selected from a cup, pouch, bag or box.

19. The packaged food product of claim 16, wherein the single-serving container is a cup and the baking mix is sealed within the cup.

20. The packaged food product of claim 17, wherein the cup is between about 3 and about 4 inches high.

21. The packaged food product of claim 18, wherein the outer diameter of the top of the cup is about 3 to about 4 inches wide.

22. The packaged food product of claim 19, wherein the outer diameter of the bottom of the cup is from about 2 to about 3 inches wide.
